(19) United States
(12) Patent Application Publication
(10) Pub. No.: US 2008/0165960 A1
(43) Pub. Date: Jul. 10, 2008

(54) SYSTEM FOR PROVIDING COPYRIGHT-PROTECTED VIDEO DATA AND METHOD THEREOF

(75) Inventor: Byung Hyun Woo, Seoul (KR)

Correspondence Address: PEARNE & GORDON LLP, 1801 EAST 9TH STREET, SUITE 1200, CLEVELAND, OH, 44114-3108, US

(73) Assignee: TAGSTORY CO., LTD., Seoul (KR)

(21) Appl. No.: 11/782,278

(22) Filed: Jul. 24, 2007

(30) Foreign Application Priority Data
Jan. 9, 2007 (KR) 10-2007-0002566

(51) Int. Cl. H04N 7/167

(52) U.S. Cl. 380/201

(57) ABSTRACT

A video data service system includes a web server for providing a web page which authenticates a member as a copyright holder and registers the member as a first member; an encoding server for inserting an identifier representing the copyright holder corresponding to the first member into first format video data uploaded from the first member, and for encoding the first format video data into second format video data; a media file server for storing therein the encoded second format video data; and a database server for storing therein first member information inputted by the first member and link information for accessing the second format video data on a web. The link information is transmitted to a video data distribution system through the web server.

### TECHNICAL FIELD

The present disclosure relates to a system for providing video data service and method thereof; and, more particularly, to a system for efficiently providing video data, of which copyrights are protected online, with a news site or a portal site and method thereof.

### BACKGROUND

Recently, an online news service system has been operated mainly based on text data and image data. Meanwhile, video news data include therein news information containing both of audio data and video data, so that only an expert group can produce the video news data. Accordingly, it is difficult for non-experts to produce and distribute the video news data.

However, if the video data, e.g., video data on spot view or brief interview, are inserted into news data of a text type, persuasiveness and realities of the news data can be more enhanced.

In the meantime, a conventional video data service system has been run as follows: video data are stored in a specific file server; access information thereof is published; and then the video data are played on other news sites, portal sites, blogs or personal homepages by using the access information.

Moreover, since the amount of the video data is greatly larger than that of the image data, the video data has been provided by limited users or data providing enterprises. However, as data transfer rate of recent internet line is being increased and a video camera device is being spread, distribution of video data files made by general users instead of professionals is being popularized.

Specifically, UCC (User Created Contents), e.g., video data created by a general user or video data made by editing pre-existing video data, are being distributed widely on the purpose of personal advertisements as well as news information deliveries.

FIG. 1 shows a schematic diagram of a conventional video data service system.

As shown in FIG. 1, the video data service system includes video camera devices 10 and 20 of a video data provider; a video data edition device 11; a video data platform server 30; a video data distribution server 40 and video data receipt clients 50, 51 and 52.

The video data provider can directly transmit video data recorded by the video camera devices 10 and 20 to the video data platform server 30. Further, the video data provider can edit the recorded video data by using the video data edition device 11 and transmit them to the video data platform server 30.

The video data platform server 30 stores therein the transmitted video data and provides access information thereof to the video data distribution server 40. The video data platform server 30 and the video data distribution server 40 may be operated in a separate system or an integrated system.

The video data distribution server 40 may be a portal site or a news site, or can be operated by a professional service site for distributing video data. The video data distribution server 40 provides access information of video data together with text/image data, thereby allowing the clients 50, 51 and 52 to play the video data stored in the video data platform server 30 through the use of the access information.

The clients 50, 51 and 52 can play the video data by using a video data play program installed thereon. Further, it has been recently developed to encode video data to a flash file having an extension of “flv”. Using the flash file, the video data can be played without an additional video data play program.

The flash file provides various editing functions such as a special effect, overlay and the like, unlike general video data file. Moreover, a link connecting to other site or an advertisement can be added to the flash file so that the video data can be distributed and shared commercially.

However, as sharing of the video data is accelerated by the conventional video data service system, copyright infringement has been frequently arisen. Furthermore, if video data articles directly made by the press, e.g., newspaper or broadcasting station, are freely shared with other news sites through the video data platform server 30, efforts of the video data article provider may be come to nothing.

Accordingly, a participant of the conventional video data service system has a risk of being accused by a copyright holder.

Moreover, due to the possibility of the copyright infringement, the operator of the video data platform server 30 cannot operate the video data service system without anxiety because the operator of the video data platform server 30 shares profit of advertisement inserted into the video data, in return for providing the storage volume and the access information of the video data.

That is, if the copyright infringement occurs, the operator of the video data platform server 30 will have risk of bearing the blame for restitution of unjust enrichment or damage compensation.

Although the copyright-infringed video data are deleted manually based on the user's report or self inspection in the conventional video data service system, it takes too much time and resources.

### SUMMARY

It is, therefore, an object of the present invention to provide a video data service system for making a reliable business model by preventing the possibility of the copyright infringement and method thereof.

It is another object of the present invention to provide a video data service system for easily inserting the video data into text information.

It is still another object of the present invention to provide a video data service system for distributing online video news by sharing copyright-protected video data, thereby allowing video data provider and video data user to make the profits.

In accordance with one aspect of the invention, there is provided a video data service system including: a web server for providing a web page which authenticates a member as a copyright holder and registers the member as a first member; an encoding server for inserting an identifier representing the copyright holder corresponding to the first member into first format video data uploaded from the first member, and for encoding the first format video data into second format video data; a media file server for storing therein the encoded second format video data; and a database server for storing therein first member information inputted by the first member and link information for accessing the second format video data on a web, wherein the link information is transmitted to a video data distribution system through the web server.

In accordance with another aspect of the invention, there is provided a news service system by using video data transmitted from an online article transmission system, including: a video data platform system for authenticating that first format video data are transmitted from the online article transmission system, then generating and storing second format video data by encoding the first format video data, providing link information of the second format video data such that the online article transmission system combines a text article with the link information of the second format video data.

In accordance with still another aspect of the invention, there is provided a method for providing a video data service, including the steps of: (a) receiving member information from a user device through a web server; (b) receiving copyright holder authentication information for proving that a user holds a copyright on video data to be uploaded; (c) issuing an authentication key based on the member information and the copyright holder authentication information, and performing a copyright holder authentication based on whether the authentication key is sent back or not; (d) performing a copyright verification of video data uploaded from a member authenticated as the copyright holder based on the member information and the copyright holder authentication information; (e) if the video data is verified to have the copyright, converting the video data in order to insert thereinto an identifier of the copyright holder; and (f) publishing link information for allowing users to access the converted video data on a web.

In accordance with still another aspect of the invention, there is provided a method for providing a copyright-protected video data service, the method including the steps of: (a) receiving information of a first member who provides copyright-protected video data; (b) receiving information of a second member allowed to distribute the copyright-protected video data; (c) receiving information of a third member requiring advertisement to be inserted into the copyright-protected video data; (d) inserting the advertisement into the copyright-protected video data based on correlation of the information of the first member and the third member; (e) tracing an access object according to an access request for the copyright-protected video data into which the advertisement is inserted; and (f) generating statistical data on advertisement profit distribution between the first member and the second member based on the results of the step (e).

### BRIEF DESCRIPTION OF THE DRAWINGS

The disclosure may best be understood by reference to the following description taken in conjunction with the following figures:

FIG. 1 shows a schematic diagram of a conventional video data service system;

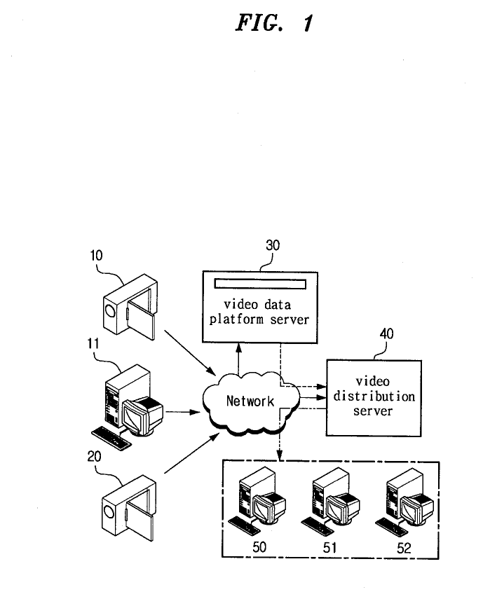

FIG. 2 sets forth a schematic diagram of a video news providing system in accordance with one embodiment of the present invention;

FIG. 3 presents a block diagram showing a video data platform system in accordance with one embodiment of the present invention;

FIG. 4 illustrates a signal flowchart describing a member registration process in accordance with one embodiment of the present invention;

FIG. 5 offers a signal flowchart describing a video data registration process in accordance with one embodiment of the present invention;

FIG. 6 depicts a signal flowchart showing a video-inserted news article distribution system in accordance with one embodiment of the present invention;

FIG. 7 shows a flowchart describing a member information registering method in accordance with one embodiment of the present invention;

FIG. 8 sets forth a flowchart describing a video data registering method in accordance with one embodiment of the present invention;

FIG. 9 presents a flowchart describing a video data editing method in accordance with one embodiment of the present invention;

FIG. 10 illustrates a flowchart describing a method for transmitting link information of the edited video data in accordance with one embodiment of the present invention;

FIG. 11 presents a flowchart describing a method for generating statistical data according to video data access in accordance with one embodiment of the present invention; and

FIG. 12 provides a flowchart describing a method for matching video data with an advertisement in accordance with one embodiment of the present invention.

### DETAILED DESCRIPTION

In the following description, numerous specific details are set forth. It will be apparent, however, that these embodiments may be practiced without some or all of these specific details. In other instances, well known process steps or elements have not been described in detail in order not to unnecessarily obscure the disclosure.

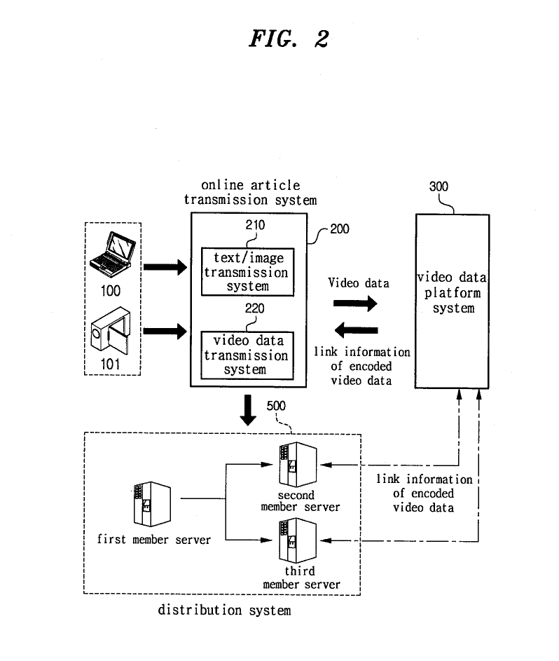

FIG. 2 sets forth a schematic diagram of a video news providing system in accordance with one embodiment of the present invention.

First of all, a member authenticated as a copyright holder of video data is referred as a special member (e.g., a news reporter of the press). The special member uploads video data to an online article transmission system 200 from a video camera device 101 or a user device 100 capable of communicating with each other in a network.

The online article transmission system 200 is operated by the press, and has a function of editing articles and transmitting them to the news site after collecting articles from the news reporter online. In accordance with one embodiment of the present invention, the online article transmission system 200 includes a text/image transmission system 210 and a video data transmission system 220.

The text/image transmission system 210 stores therein text or image data received from the news reporter, and edits and/or transmits them to a distribution system 500.

Meanwhile, the video data transmission system 220 transmits the video data received from the user device 100 of the special member to a video data platform system 300, and receives link information of the video data encoded by the video data platform system 300. The link information is inserted into the text/image article and transmitted to the distribution system 500.

The video data platform system 300 authenticates copyright of the video data. If the video data has a copyright, the video data platform system 300 inserts copyright indication into the video data, or inserts an advertisement into the copyright-protected video data. Thereafter, the copyright-protected video data are encoded in a specific format and stored in the video data platform system 300. Then, the video data platform system 300 transmits the link information of the encoded video data stored therein to the video data transmission system 220, and traces who requests an access to the video data whenever the encoded video data are called through the link information.

The distribution system 500 may include a plurality of member server. Further, the distribution system 500 may include a server of the special member having the copyright of the video data as well as a server of a cooperated member and a server of a general member.

If the special member server is referred to as a first member server; the cooperated member server is referred to as a second member server; and the general member server is referred to as a third member server, the second member server or the third member server can connect to the first member server or the video data platform system 300 and access the video data by inserting the link information of the video data into their news site or portal site in an HTML format.

Hereinafter, configurations of the video data platform system 300 will be described in detail.

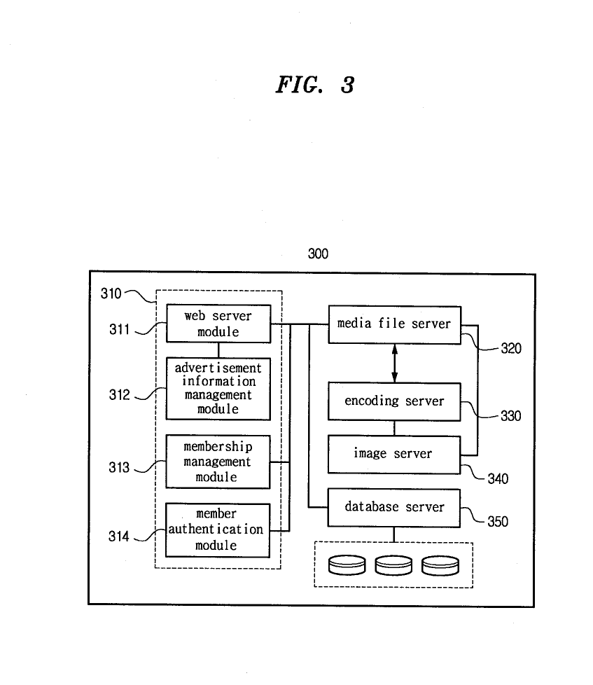

FIG. 3 presents a block diagram showing a video data platform system in accordance with one embodiment of the present invention.

The video data platform system 300 includes a web server 310, a media file server 320, an encoding server 330, an image server 340 and a database server 350.

The web server 310 has a web server module 311, an advertisement information management module 312, a membership management module 313 and a member authentication module 314. The above-described modules may be separately provided, or may be provided as an integrated program code in the web server 310.

The web server 310 provides a web page accessible by a user, and performs a member registration, a copyright holder registration, a copyright holder authentication, a copyright-protected video data verification, a link information publication, an advertisement insertion request receipt, a match of an advertisement with the video data and a statistical data generation.

The media file server 320 stores therein the video data transmitted from the web server 310 and encodes the video data, and then stores therein the encoded video data. If the encoded video data are requested to be accessed through the web server 310, the media file server 320 transmits the encoded video data to a site which requests to access thereto.

The encoding server 330 encodes the transmitted video data in a specific format. A plurality of video data may be encoded in the “flv” format by the encoding server 330, the “flv” format representing the flash file. Further, a watermark, a link or an advertisement can be inserted into the encoded video data on the basis of member information and advertisement information.

The image server 340 generates a main image or an index image of the encoded video data, and stores the image corresponding to the encoded video data.

The database server 350 stores therein an access URL (the link information) or HTML information of the encoded video data, member information, property information, authentication information of copyright holder and verification information of copyright, statistical information on video data access, and tag information corresponding to comment of the video data. If other components request the information stored in the database server 350, the database server 350 searches the information and transmits them thereto.

The web server module 311 embedded in or integrated with the web server 310 provides a web page on a web site, which is accessible by users including a video data provider, an advertiser and a general user.

The advertisement management module 312 matches advertisement request information collected from the advertiser with advertisement permission information of the video data provider, and generates statistical data according to the video data access.

The membership management module 313 gives a proper authority to each member according to the properties of the member, e.g., a copyright holder member, a video data sharing member, an advertisement request member, a general member or the like, and manages member information.

The member authentication module 314 authenticates a copyright holder among the members and also authenticates a member having a video data sharing authority. Further, the member authentication module 314 also verifies whether video data uploaded by a member has a copyright or not.

As described above, the components 311, 312, 313 and 314 of the web server 310 may be separately provided, or may be provided as a unity. The explanation will be followed for convenience on the assumption that web server 310 executes the above-described functions as a unity.

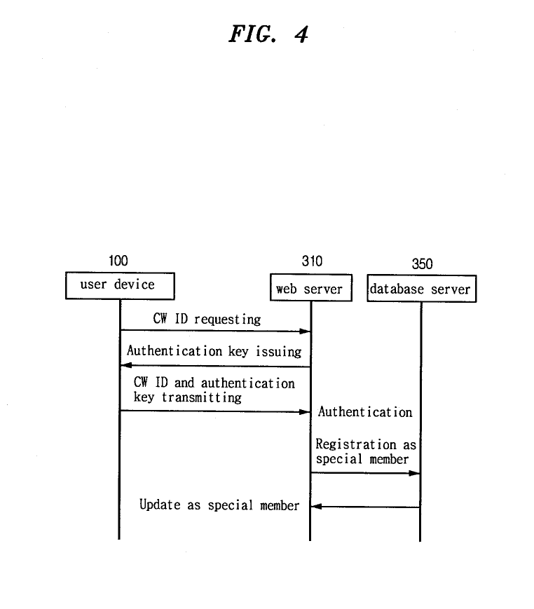

FIG. 4 illustrates a signal flowchart describing a member registration process in accordance with one embodiment of the present invention.

The user device 100 includes a client unit capable of connecting to the web server 310 online. A user wanting a member registration requests an ID(CW ID) of a special member through the user device 100, the special member capable of uploading copyright-protected video data.

In response to the above request, the web server 310 issues an authentication key for checking whether the member has the CW ID or not. In accordance with one embodiment of the present invention, the authentication key may be transmitted to an e-mail account designated by the user device 100. The user device 100 receives the authentication key and inputs the received authentication key, thereby performing a special member authentication.

In accordance with one embodiment of the present invention, in order to judge whether a member is a copyright holder or not, the e-mail account itself to which the authentication key is issued may be used. For example, an e-mail account (kim@chosun.com) having an e-mail domain (chosun.com) of mass media corporation can be CW ID since the mass media domain cannot be easily accessed by the general member. Accordingly, in addition to the mass media domain, since the authentication key can be verified only by the e-mail account, the special member capable of uploading the copyright-protected video data can be authenticated.

In accordance with another embodiment of the present invention, the CW ID may be generated according to the user's choice, and further, if the designated e-mail account, to which the authentication key is issued, is one of preset e-mail account list of the special member, a member having the e-mail account included in the e-mail account list can be authenticated as the special member.

In accordance with still another embodiment of the present invention, the special member can be authenticated without using the authentication key. For example, an operator of the web server 310 distributes an authenticated video camera device and requires an identifier of the video camera device, thereby performing the special member authentication.

Furthermore, although the video camera device is not previously authenticated, a copyright authentication of the video data itself can be performed. That is, if an identifier of the video camera device is registered, the member can be authenticated as the special member by using the identifier when uploading the video data later.

In accordance with embodiments of the present invention, an operator can select a method for previously authenticating a special member or previously storing data capable of authenticating the copyright of the video data to be uploaded later.

If the web server 310 authenticates the special member, the special member information is registered in the database server 350. If the special member has previously been registered as a general member, the general member is updated as the special member and the authentication is renewed.

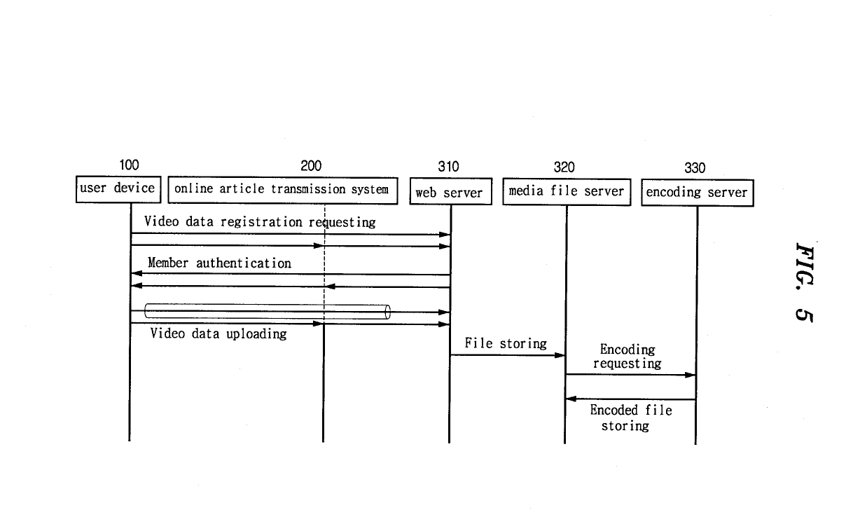

FIG. 5 offers a signal flowchart describing a video data registration process in accordance with one embodiment of the present invention.

The user device 100 requests that the web server 310 registers the photographed video data. Here, the video data registration may be directly requested through the network or may be indirectly requested through the online article transmission system 200. In case of the latter, the online article transmission system 200 installs a program (a kind of agent program) capable of authenticating the member and registering the video data in the web server 300, thereby allowing the program to perform the video data registration.

In response to the above registration request, the web server 310 judges whether a member who registers the video data is the special member or not. If the member proves to be the special member, the web server 310 authenticates the member as the special member. The authentication may be performed based on an ID and password of the member or the e-mail account thereof. In case of installation of the agent program, the web server 310 performs the registration based on the own identifier or IP address of the online article transmission system 200.

If the authentication is completed, the user device 100 uploads the photographed video data. The video data may be transmitted through the online article transmission system 200, or the agent program of the online article transmission system 200 may transmit the video data to the web server 300 through a tunneling.

The transmitted video data are stored in the media file server 320 at first, and then, the encoding server 330 encodes it into a flash file of the “flv” format. Thereafter, the encoding server 330 stores the encoded flash file in the media file server 320 again.

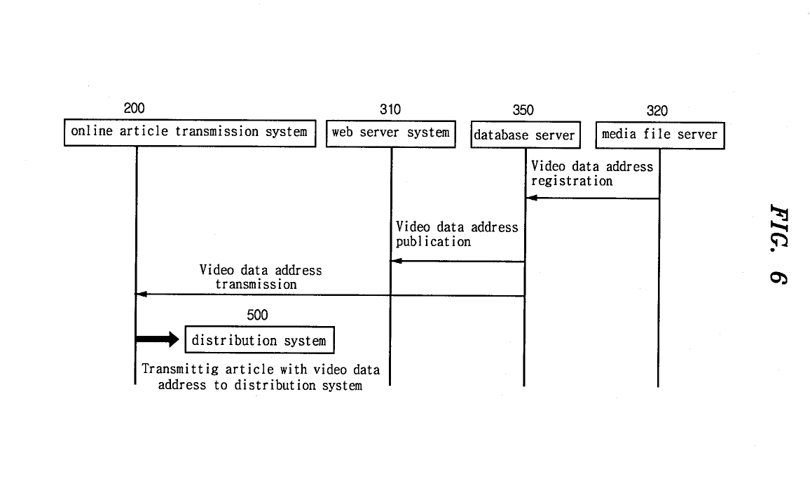

FIG. 6 depicts a signal flowchart showing a video-inserted news article distribution system in accordance with one embodiment of the present invention.

As shown in FIG. 6, after the encoded video data are stored in the media file server 320, the media file server 320 registers an address (link information) of the video data in the database server 350.

The registered address of the video data is published through the web server system 310 or transmitted to the online article transmission system 200. The address of the video data transmitted to the online article transmission system 200 is inserted into the article data having a text/image by the agent program described above. The address of the video data may be a kind of link information. Further, the article data are made out in an HTML format and provides text data and video data on the web.

After the article data are transmitted to the distribution system 500, they can be more widely distributed to a news site of the special member, a news site of other member, a portal site, a personal site or the like.

As described above, the video data service system in accordance with one embodiment of the present invention can register the copyright-protected video data by the special member management system, and also, can edit the copyright-protected video data when generating online news.

Further, the video data service system in accordance with one embodiment of the present invention provides functions of verifying the copyright of the video data itself, and also, allows both of the video data provider and the distributor to make a profit on the copyright-protected video data.

Hereinafter, embodiments of sharing and distributing the video data will be described in an aspect of a method for providing the video data based on the above-described video data service system.

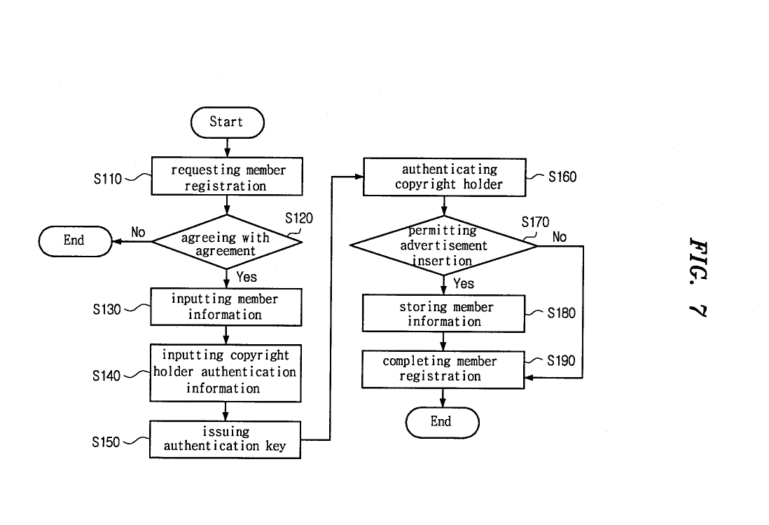

FIG. 7 shows a flowchart describing a member information registering method in accordance with one embodiment of the present invention.

The web server receives the member registration request from the user device (step S110). Then, the web server provides a prepared web page in which an agreement is included, and receives a response for agreeing with the agreement from the user device (step S120). The agreement may include a promise that a user must upload only copyright-protected video data.

In case of receiving the response for agreeing with the agreement, a web page for requesting user information is provided (step S130). The user information may be directly inputted from the user device, or may be selected from previously stored lists.

A web page for inputting copyright holder authentication information is provided (step S140). As described above, the copyright holder authentication information may be the exclusive e-mail account of the special member. Further, the identifier of the video camera device previously set in the video data service system or that of the video camera device which is not preset may be inputted.

The authentication key for authenticating the copyright holder is issued (step S150). That is, the authentication key is issued to the e-mail address of the special member or the e-mail address inputted from the user device. The authentication key may be a key corresponding to the identifier of the preset video camera device and may be issued to the user device in offline or online authentication process.

The authentication key is transmitted to the user device for performing the member registration, and then, is inputted to the video data service system. In such case, the process for judging whether a user is a special member or not by using the authentication key and the e-mail address is performed (step S160). As described above, the copyright holder may be authenticated by judging whether the authentication key is transmitted to the limited e-mail address having the mass media domain. However, the copyright holder may be authenticated by verifying the copyright of the video data later after judging whether data inputted from the user device satisfies predetermined conditions assuming the copyright holder. If the user is authenticated by the inputted data, the copyright of the video data to be uploaded later will be verified by using the inputted data. The copyright verification of the video data will be explained later in detail.

It may be requested whether advertisement insertion is permitted or not during the member registration (step S170). If the member permits the advertisement insertion, the member can select the advertisement category (step S180). The advertisement category may include the product, the service or the like and may be selected based on the advertiser.

After selecting the advertisement category, the member information collected in the above steps is stored in the database server (step S190). If the member does not want to insert the advertisement, the member information is stored in the database server without selecting the advertisement category.

According to the flowchart shown in FIG. 7, if the special member having the copyright is registered, it can be regarded that the video data to be uploaded by the special member have also the copyright. Further, after assuming that the video data has the copyright, the copyright of the uploaded video data can be easily authenticated based on the above assumption.

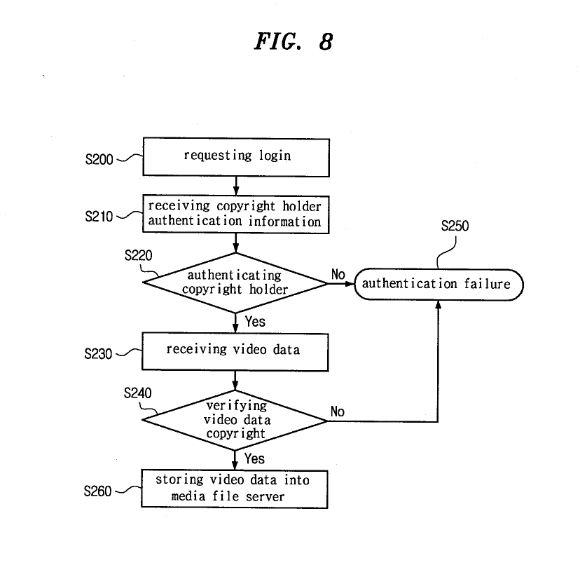

FIG. 8 sets forth a flowchart describing a video data registering method in accordance with one embodiment of the present invention.

A login request is received from the user device which requires the video data to be registered (step S200). The login request may be directly received from the user device, or may be received from the agent program of the online article transmission system.

The web server receives the copyright holder authentication information together with the login request (step S210). The copyright holder authentication information includes at least one of the member ID/Password, the e-mail account, the identifier of the video camera device.

The web server performs the authentication based on the copyright holder authentication information (step S220). In authenticating the copyright holder, it is checked whether the copyright holder authentication information stored in the database server is equal to the member ID/password, the e-mail account or the identifier of the video camera device. If the copyright holder authentication cannot be accomplished, a message of the authentication failure is printed out on screen and the video data registration process is terminated (step S250).

If the copyright holder authentication is accomplished (or if the member is assumed as the copyright holder based on the member information previously stored), video data to be uploaded are received (step S230).

In the course of receiving the video data, it is checked whether the video data has already a copyright (step S240). A method for verifying the copyright of the video data may be classified into roughly two methods.

In accordance with a first method, it is checked whether the video data is transmitted through the exclusive e-mail account of the special member or the online article transmission system. Specifically, if the video data is transmitted through the e-mail account of the special member or transmitted from the certain IP address of the online article transmission system (or transmitted in such a manner that the identifier of the online article transmission system is inserted), the copyright authentication is regarded to be successful without checking the copyright of the video data itself.

In accordance with a second method, it is checked whether the video data has a previously registered identifier by analyzing metadata information of the transmitted video data. The metadata information is included in the header of the photographed video data and provides detail information thereof. For example, it includes a size, a playing time, an identifier of the video camera device, date of the video data or the like. Accordingly, after analyzing the metadata information, the copyright of the uploaded video data is verified by judging whether the metadata information equals to the identifier corresponding to the special member.

Next, the copyright-protected video data are stored in the media file server and the video data registration is completed (step S260). If the copyright of the video data cannot be verified, the verification is regarded as failure and then the video data registration is terminated (step S250).

Hereinafter, a method for converting the copyright-protected video data into the video data capable of being distributed or shared will be described.

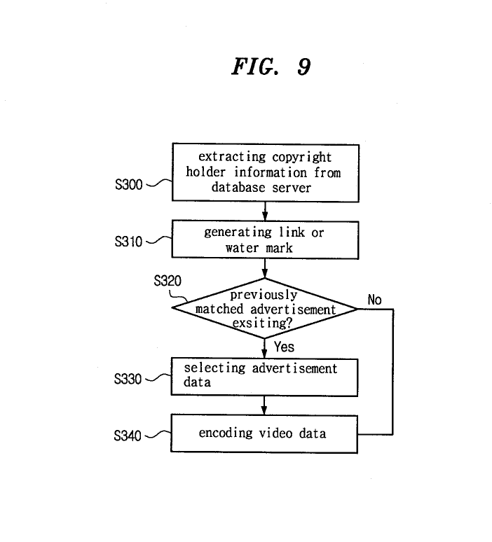

FIG. 9 presents a flowchart of a video data editing method in accordance with one embodiment of the present invention.

If the video data are registered through the steps shown in FIG. 8, the copyright holder information is extracted from the database server (step S300). As described above, the copyright holder information may be the name, nickname or ID of the copyright holder, and also may be the firm name of the mass media.

A link for connecting to the copyright holder's site is generated by using the copyright holder information (step S310). Further, a water mark for visually representing the copyright holder can be generated. The water mark includes a water mark in which copy prohibition technique is included or an overlay in which copyright display technique is included.

It is checked whether there is an advertisement previously matched with the uploaded video data or not (step S320). If the advertisement insertion is permitted and the advertisement category is selected in the step of the member registration, the advertisement data are selected (step S330).

The video data are encoded in a predetermined format by combining the link, the water mark and the advertisement data (step S340). The encoding process is performed by the encoding server, and for example, the video data may be encoded in the “flv” format by using the codec of the ON2 Technologies, Inc.

Although the encoding process is performed at the last step in one embodiment of the present invention described above, it is well known to the ordinary person skilled in the art that the link, the water mark and the advertisement information may be inserted after encoding the video data.

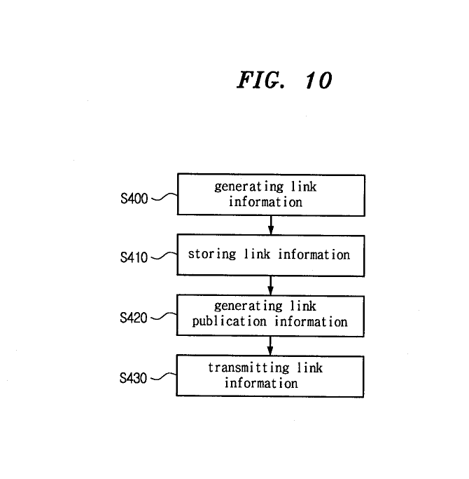

FIG. 10 illustrates a flowchart of a method for transmitting link information of the edited video data in accordance with one embodiment of the present invention.

As described above, the encoded video data are stored in the media file server and the link information for accessing to the stored video data is generated (step S400). The link information is generated in a URI(Universal Resource Indicator) format through which the encoded video data can be accessed on the web. The link information is stored in the database server (step S410).

Moreover, in accordance with another embodiment of the present invention, the encoded video data are stored as a player file depending on the designer's choice because the “flv” file described above may integrate the encoded video data and the player into one file.

Further, if the video data are stored in the player format, the respective player has his own identifier. Although the link information cannot directly access the player, the link information can be link information transmitting a request for accessing the player.

If the web server receives the identifier of the player, the web server accesses the player file through the media file server, thereby providing it to the requester. Accordingly, one embodiment of the present invention may include a direct link to the video data stored in the media file server and an indirect link through which the video data can be accessed. Hereinafter, the direct link and the indirect link are referred to as a “link” for convenience.

The stored link information generates link publication information in order that the member or the visitor connected to the web server can copy them (step S420). The link publication information may include a simple address of the video data as well as the video data information, the ment, the tag, which are inputted from the video data provider when uploading the video data.

Further, the stored link information is transmitted to the user device of the video data provider or the online article transmission system (step S430). The transmitted link information is included in an online news page after the online article transmission system combines the text/image therewith.

Furthermore, other member or third parties may insert the link information into the news by extracting only the link information in the online news page. Since the copyright of the video data is verified, third parties (or member having proper authorities) can freely reuse them if the copyright holder permits the sharing of the video data, the advertisement insertion or the like.

However, it is not probable that the confusion of video data source occurs although the video data are played on other person's homepage because the link or the water mark for representing the copyright holder are inserted into the video data as described in FIG. 9.

In aspect of the third parties for distributing the video data, they also distribute the advertisement inserted into the video data while using the video data in their articles. Accordingly, as the video data are distributed more and more, the copyright holder has more advertisement profits.

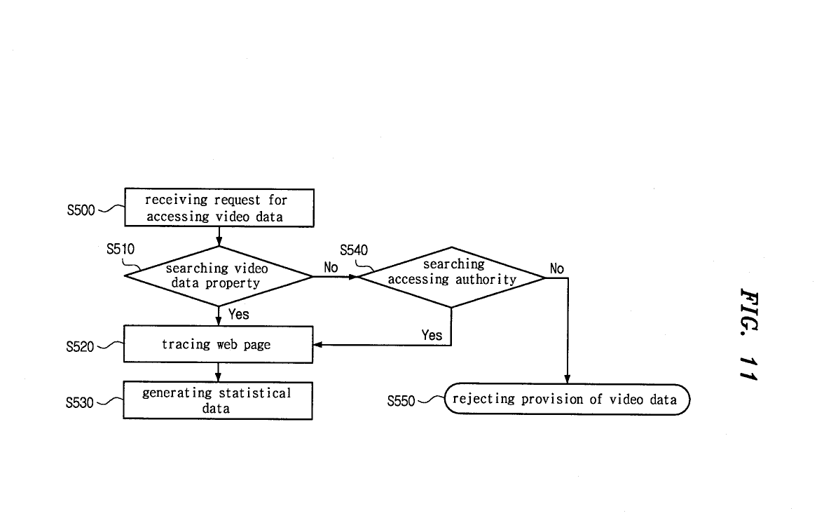

FIG. 11 presents a flowchart of a method for generating statistical data according to video data access in accordance with one embodiment of the present invention.

The web server receives the request for accessing the video data through the link information described above (step S500).

Then, the property of the video data is searched (step S510). The property of the video data can be classified into a first property and a second property.

The first property indicates that the copyright holder allows any user device to freely access the video data.

The second property indicates that the copyright holder allows only the predetermined user to access the video data. For example the second property may be assigned if the special member affiliates with a certain news site or portal site of the mass media in distributing the video date. According to the designer's selection, the advertisement profits of the video data having the second property may be divided into the copyright holder and the distributor.

If the video data has the second property, it is checked whether a proper access authority exists or not by inspecting the URL or the IP address of the requester (step S540). If there is access authority, the web page requesting to access the video data is traced (step S520) and statistical data are generated (step S530). However, if there's no access authority, the video data is not provided (step S550).

If the video data has the first property, it is possible that access statistical data of other member cooperating with the copyright holder are obtained by tracing the web page after transmitting the video data.

The statistical data includes the accessor, access number, access time of the video data, the play time, the exposure number to the advertisement or the like. Further, the advertisement profits may be divided into the copyright holder, the distributor and the video data platform server provider.

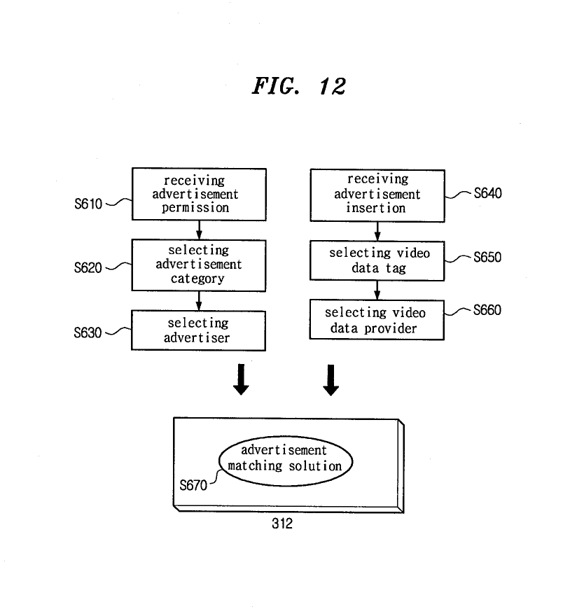

FIG. 12 provides a flowchart of a method for matching the video data with an advertisement in accordance with one embodiment of the present invention.

The advertisement permission is received from the user device (step S610). The advertisement permission may be performed at any step of the member registration or the video data registration.

Thereafter, a web page which requires to select the advertisement category is provided (step S620). The advertisement category may include the product, the service and the like. The advertisers requesting the advertisement insertion may be provided and selected (step S630).

The advertisement insertion request is received from the advertiser (step S640). This step further includes steps of receiving the advertisement product, the service name, the advertisement expression or the advertisement information made by the advertiser.

The video data tag showing comments of the video data is selected (step S650). As described above, after the copyright holder makes out and inputs the tag, the tag is stored in the database server. Although one video data has a plurality of tag and a plurality of video data has same tag, the tag can be used as a key word capable of classifying and searching the video data.

The advertiser selects the video data provider (step S660). The list of the special member capable of uploading the copyright-protected video data may be provided to the advertiser.

As described above, after receiving requests of the video data provider and the advertiser, if the video data are registered, an advertisement matching solution of the advertisement information management module 312 automatically matches the registered video data with the advertisement (step S670). The advertisement matching solution performs the advertisement matching process in the correlationship order based on the information inputted at the steps of S610, S620, S630, S640, S650 and S660. For items which are not inputted at the steps of S620, S630, S650 and S660, the matching process may be performed in conditions that any matches of the items make no difference.

In accordance with one embodiments of the present invention, the copyright-protected video data are verified by managing the special member, thereby allowing the video data platform operator to reliably operate the platform business. Further, live news can be provided by inserting video data into the news page in a simple method without the professional video camera device and the video data providing infra. Furthermore, the video data can be easily transmitted to the cooperation news site or portal site, thereby allowing the distributor to easily distribute the video data.

Moreover, the provider and the distributor of the copyright-protected video data are connected with each other and the statistical data according to the video data access are generated, thereby allowing the advertisement profits to be clearly divided into the video data provider, the video data distributor and the video data platform operator. As described above, since the video data are freely distributed among the cooperation members, the distributor can freely use the great amount of the video data and the video data provider has much more advertisement profits through the distributor.

Further, while various functional components have been described in the embodiments of the present disclosure, it should be appreciated the embodiments can be implemented in hardware, software, firmware, middleware or a combination thereof and utilized in systems, subsystems, components, or sub-components thereof. When implemented in software, the elements of the embodiments are the instructions/code segments to perform the necessary tasks. The program or code segments can be stored in a machine readable medium, such as a processor readable medium or a computer program product, or transmitted by a computer data signal embodied in a carrier wave, or a signal modulated by a carrier, over a transmission medium or communication link. The machine-readable medium or processor-readable medium may include any medium that can store or transfer information in a form readable and executable by a machine (e.g. a processor, a computer, etc.).

While the invention has been shown and described with respect to the embodiments of the present invention, it will be understood by those skilled in the art that various changes and modifications may be made without departing from the spirit and scope of the invention as defined in the following claims.

What is claimed is:

1. A video data service system comprising:
a web server for providing a web page which authenticates a member as a copyright holder and registers the member as a first member;
an encoding server for inserting an identifier representing the copyright holder corresponding to the first member into first format video data uploaded from the first member, and for encoding the first format video data into second format video data;
a media file server for storing therein the encoded second format video data; and
a database server for storing therein first member information inputted by the first member and link information for accessing the second format video data on a web,
wherein the link information is transmitted to a video data distribution system through the web server.

2. The system of claim 1, wherein authenticating the copyright holder is performed by issuing an authentication key to an e-mail account of the member who requires to be registered as the first member and then determining whether the authentication key is sent back or not.

3. The system of claim 2, wherein the copyright holder is authenticated if the e-mail account belongs to a predetermined e-mail domain.

4. The system of claim 3, wherein the e-mail account is chosen as the identifier (ID) of the first member.

5. The system of claim 1, wherein the web server includes:
a web server module for providing a web page allowing a client device to access the second format video data through the connection of the client device and the link information; and
an advertisement information management module for collecting advertisement request information from an advertiser and matching advertisement permission information of the first member with the advertisement request information.

6. The system of claim 5, wherein the web server further includes a membership management module for classifying members into the first member, a second member allowed to distribute the first format video data provided by the first member and a third member who requires an advertisement to be inserted into the first format video data, and then giving a proper authority to each member.

7. The system of claim 5, wherein the web server further includes a member authentication module for authenticating copyright of the first format video data by using the first member information.

8. The system of claim 7, wherein the first member information has an e-mail account.

9. The system of claim 7, wherein the first member information has an IP address on a network through which the first format video data are transmitted.

10. The system of claim 7, wherein the first member information has an identifier previously set in the video data service system, and the copyright authentication is performed by judging whether the preset identifier equals to an identifier contained in metadata of the transmitted first format video data or not.

11. The system of claim 1, further comprising an image server for storing therein a part of still pictures of the second format video data in correspondence with the second format video data.

12. The system of claim 1, the first member information has the identifier of the first member, and the encoding server encodes the first format video data to display the identifier of the first member.

13. The system of claim 12, wherein an extension of the second format video data is “flv”; the link information is provided by using a URL; and the identifier of the first member is embedded in the URL.

14. A news service system by using video data transmitted from an online article transmission system, comprising:
a video data platform system for authenticating that first format video data are transmitted from the online article transmission system, then generating and storing second format video data by encoding the first format video data, providing link information of the second format video data such that the online article transmission system combines a text article with the link information of the second format video data.

15. The system of claim 14, wherein if a site accesses the second format video data through the link information, the video data platform system transmits the second format video data to the site.

16. The system of claim 15, wherein if the site accesses the second format video data, the video data platform system traces the site and generates statistical data according to an access object, an access frequency or the like.

17. A method for providing a video data service, comprising the steps of:
(a) receiving member information from a user device through a web server;
(b) receiving copyright holder authentication information for proving that a user holds a copyright on video data to be uploaded;
(c) issuing an authentication key based on the member information and the copyright holder authentication information, and performing a copyright holder authentication based on whether the authentication key is sent back or not;
(d) performing a copyright verification of video data uploaded from a member authenticated as the copyright holder based on the member information and the copyright holder authentication information;
(e) if the video data is verified to have the copyright, converting the video data in order to insert thereinto an identifier of the copyright holder; and
(f) publishing link information for allowing users to access the converted video data on a web.

18. The method of claim 17, wherein the copyright holder authentication information has predetermined domain information of an e-mail.

19. The method of claim 17, wherein the copyright holder authentication information has preset identifier information, and the copyright verification is performed by judging whether the preset identifier information equals to an identifier contained in metadata of the transmitted video data or not.

20. The method of claim 17, wherein the step (e) includes a step of inserting previously stored advertisement information into the video data.

21. A method for providing a copyright-protected video data service, the method comprising the steps of:
(a) receiving information of a first member who provides copyright-protected video data;
(b) receiving information of a second member allowed to distribute the copyright-protected video data;
(c) receiving information of a third member requiring advertisement to be inserted into the copyright-protected video data;
(d) inserting the advertisement into the copyright-protected video data based on correlation of the information of the first member and the third member;
(e) tracing an access object according to an access request for the copyright-protected video data into which the advertisement is inserted; and
(f) generating statistical data on advertisement profit distribution between the first member and the second member based on the results of the step (e).

22. The method of claim 21, wherein the step (a) includes at least one of the steps of receiving information on whether advertisement insertion is permitted or not; selecting an advertisement category; and selecting an advertiser, and wherein the step (c) includes at least one of the steps of selecting tag serving as comment of the video data into which the advertisement is inserted; and selecting a video data provider.
